(19) United States
(12) Patent Application Publication
(10) Pub. No.: US 2011/0036688 A1
(43) Pub. Date: Feb. 17, 2011

(54) Conveyor having a grip unit

(76) Inventor: Yen-Yu Chen, Changhua City (TW)

Correspondence Address: TESSARI PATENT LAW GROUP, PLLC, 301 LINDENWOOD DRIVE - SUITE 206, MALVERN, PA, 19355, US

(21) Appl. No.: 12/583,050

(22) Filed: Aug. 13, 2009

(51) Int. Cl. B65G 17/20; B65H 29/02

(52) U.S. Cl. 198/678.1; 414/226.02

(57) ABSTRACT

A conveyor includes a track and a grip unit. The grip unit includes a main body having a slide groove that receives slidably the track, a push piece provided on the track at a predetermined position and having a pushing surface to face the slide groove, a push rod inserted movably into the slide groove to abut against the pushing surface, a resilient restoring element for biasing the push rod upwardly, two grip arms connected pivotally to the main body and disposed respectively on two opposite sides of the push rod, and two spring members each disposed between the main body and a respective grip arm to bias one grip arm toward the other grip arm so that the grip arms cooperate with each other to grip an object therebetween. The push rod is movable downwardly to push the object when the push rod abuts against the pushing surface.

### BACKGROUND OF THE INVENTION

1. Field of the Invention

This invention relates to a conveyor having a grip unit.

2. Description of the Related Art

Referring to FIGS. 1 to 3, a conventional conveyor 3, as disclosed in U.S. Pat. No. 7,207,424, includes a track 31 extending along a transport direction (T), two cam members 32 respectively disposed on two opposite sides of the track 31 and extending along the transport direction (T), and a grip unit 4. Each cam member 32 has a flat straight section 321 and a protruding section 322. The grip unit 4 includes a main body 41 mounted slidably on the track 31 and having an engaging groove 411, two gripping members 42 connected pivotally to the main body 41 and cooperating with each other to grip an object (not shown) to be processed therebetween, two spring members 43 biasing the gripping members 42 toward each other, and a universal connecting element 44 for engaging the engaging groove 411. Each gripping member 42 has a cam follower 421 abutting against one of the cam members 32, and a gripping end 422. In use, a plurality of the grip units 4 are connected in series by engaging a plurality of the connecting elements 44 with the respective engaging grooves 411 in the main bodies 41 of the grip units 4.

When the grip unit 4 is activated by a drive element (not shown) to move along the track 31 in the transport direction (T) and reaches the protruding sections 322 of the cam members 32, the cam followers 421 are pushed upwardly by the respective protruding sections 322, so that the gripping ends 422 of the gripping members 42 move away from each other, thereby releasing the object that is gripped therebetween. When the cam followers 421 move away from the protruding sections 322 of the cam members 32, the gripping ends 422 move again toward each other to grip the object therebetween.

Although the grip unit 4 can smoothly transport the object along the track 3 to the next processing stage, when the object must be shifted prior to the next processing stage, shifting of the object is achieved manually. For example, when the object must be electroplated in parts, after a portion of the object that extends below the gripping ends 422 has finished the electroplating process, the object is manually moved downward so as to dip the other portion of the object that extends between the main body 41 and the gripping ends 422 in an electroplating pool to electroplate the same. This kind of procedure is not only labor-intensive, but is also harmful to workers because the workers are exposed to the electroplating pool which includes chemical solutions. Further, since the object is shifted manually during the electroplating process, the object easily deviates from a normal straight position, so that a portion of the object may not be electroplated, thereby affecting the quality of the electroplated product.

### SUMMARY OF THE INVENTION

Therefore, the object of the present invention is to provide a conveyor having a grip unit that is capable of overcoming the aforementioned drawbacks of the prior art.

According to this invention, a conveyor comprises a track extending along a transport direction and a grip unit. The grip unit includes a main body disposed below the track and having a slide groove that receives slidably the track, a push piece provided on the track at a predetermined position and having a pushing surface to face the slide groove, a push rod inserted movably into the slide groove to abut against the pushing surface and projecting downwardly from the main body, a resilient restoring element for biasing the push rod upwardly, two grip arms connected pivotally to the main body and disposed respectively on two opposite sides of the push rod, and two spring members each disposed between the main body and a respective grip arm to bias one of the grip arms toward the other one of the grip arms so that the grip arms cooperate with each other to grip an object therebetween. The push rod is movable downwardly to push the object when the push rod abuts against the pushing surface.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is an exploded perspective view of a grip unit of a conventional conveyor disclosed in U.S. Pat. No. 7,207,424;

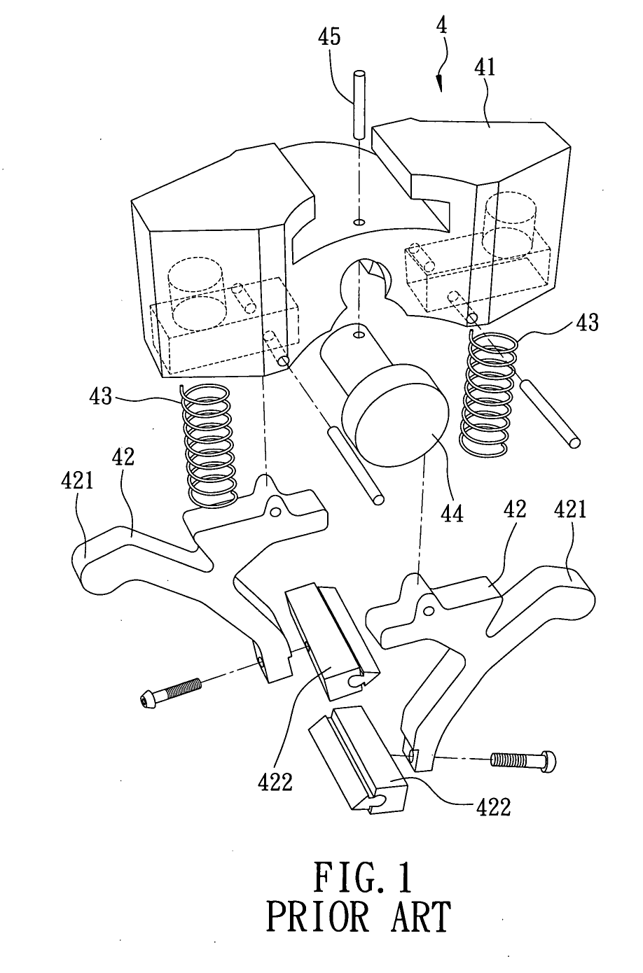

FIG. 2 is a perspective view of the grip unit of the conventional conveyor in an assembled state;

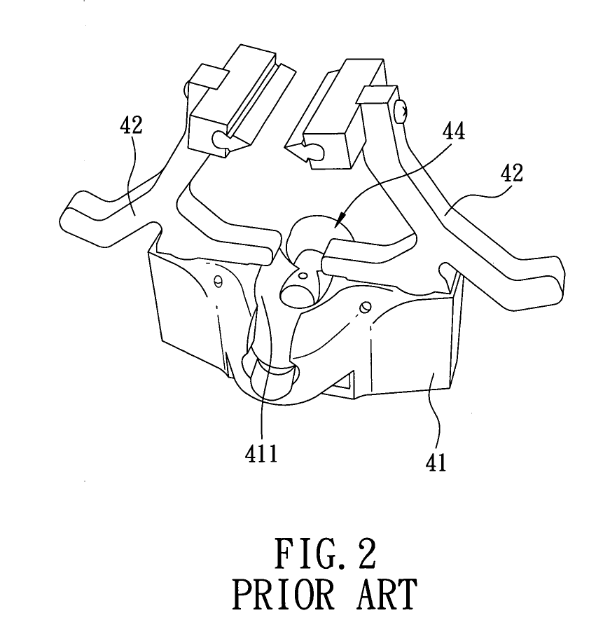

FIG. 3 is a perspective view of a plurality of the grip units of FIG. 2 connected in series along a track of the conventional conveyor;

FIG. 4 is a perspective view of a plurality of grip units connected in series along a track of a conveyor according to the preferred embodiment of this invention;

FIG. 5 is a sectional view of one of the grip units of FIG. 4;

FIG. 6 is a view similar to FIG. 5, but illustrating another position of a push rod;

FIG. 7 is a fragmentary sectional view of the conveyor of the present invention, illustrating how the push rod pushes an object downwardly; and

FIG. 8 is a view similar to FIG. 6, but illustrating the push rod in a restored original position.

### DETAILED DESCRIPTION OF THE PREFERRED EMBODIMENT

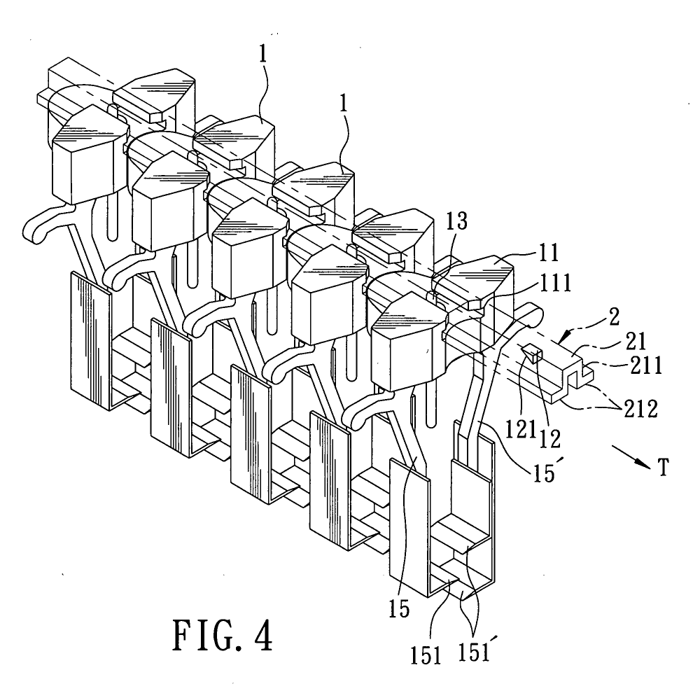

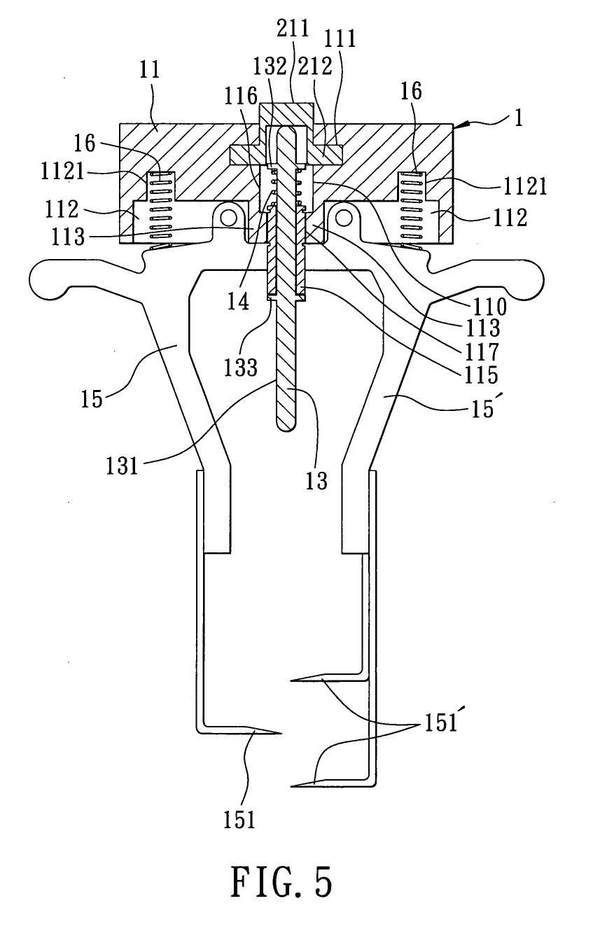

Referring to FIGS. 4 to 8, a conveyor 2 according to the preferred embodiment of the present invention is shown to comprise a track 21 and a plurality of grip units 1.

The track 21 extends along a transport direction (T), and includes an inverted U-shaped section 211, and two flanged sections 212 extending outwardly and respectively from two opposite ends of the U-shaped section 211. A push piece 12 is provided on an inner surface of the U-shaped section 211 at a predetermined position, and has a pushing surface 121. The pushing surface 121 may be a curved surface or an inclined surface. In this embodiment, the pushing surface 121 is an inclined surface that slants downwardly in the transport direction (T).

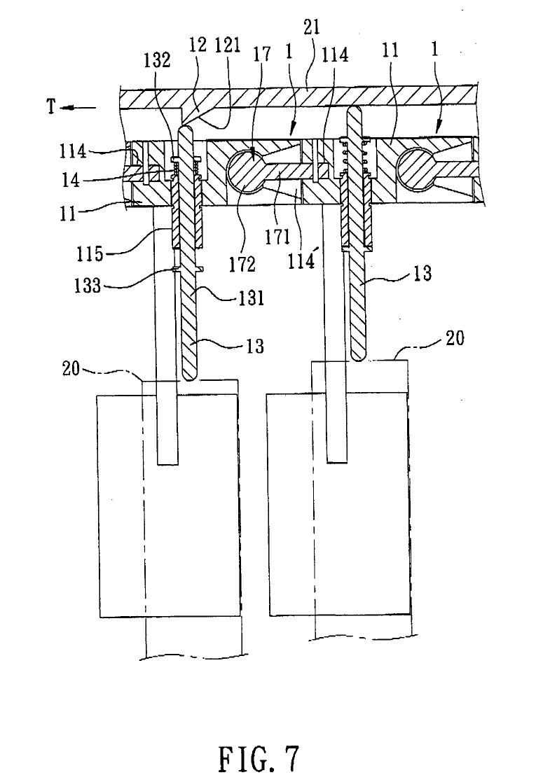

Each grip unit 1 includes a main body 11, a push rod 13, a resilient restoring element 14, two grip arms 15, 15′, and two spring members 16. The main body 11 is disposed on and extends below the track 21, and has a slide groove 111 that is sized to receive slidably the track 21 and to face the pushing surface 121, a through hole 110 extending downwardly from and communicated spatially with the slide groove 111, and two cavities 112 disposed respectively on two opposite sides of the through hole 110 and each having an extension 1121. The through hole 110 has a small diameter hole section 117 distal from the slide groove 111, and a large diameter hole section 116 between the small diameter hole section 117 and the slide groove 111. A tubular sleeve 115 is inserted fixedly and partially into the small diameter hole section 117 so that a portion thereof is disposed externally of the through hole 110. The main body 11 further has two ends opposite to each other along the transport direction (T) and respectively provided with front and rear engaging grooves 114, 114′ (see FIG. 7), and two limiting portions 113 disposed respectively on two opposite sides of the tubular sleeve 115.

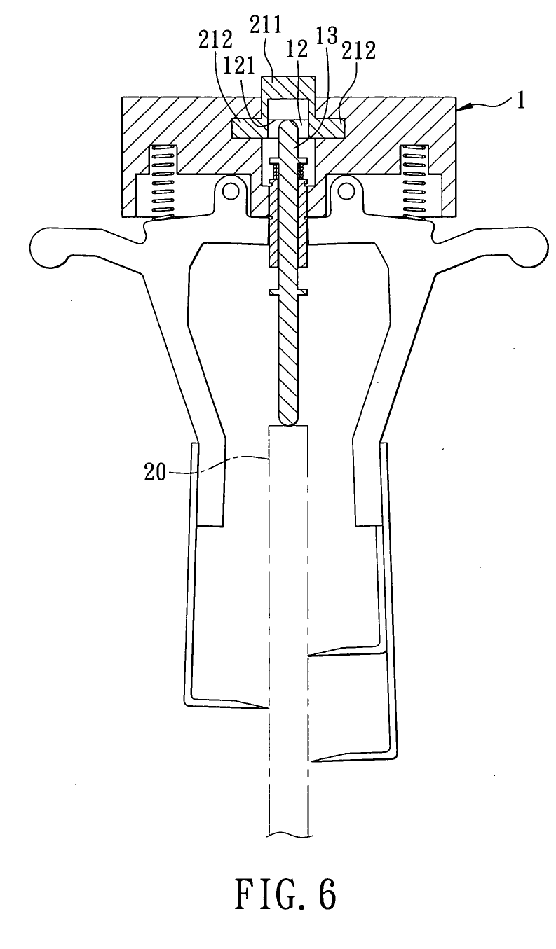

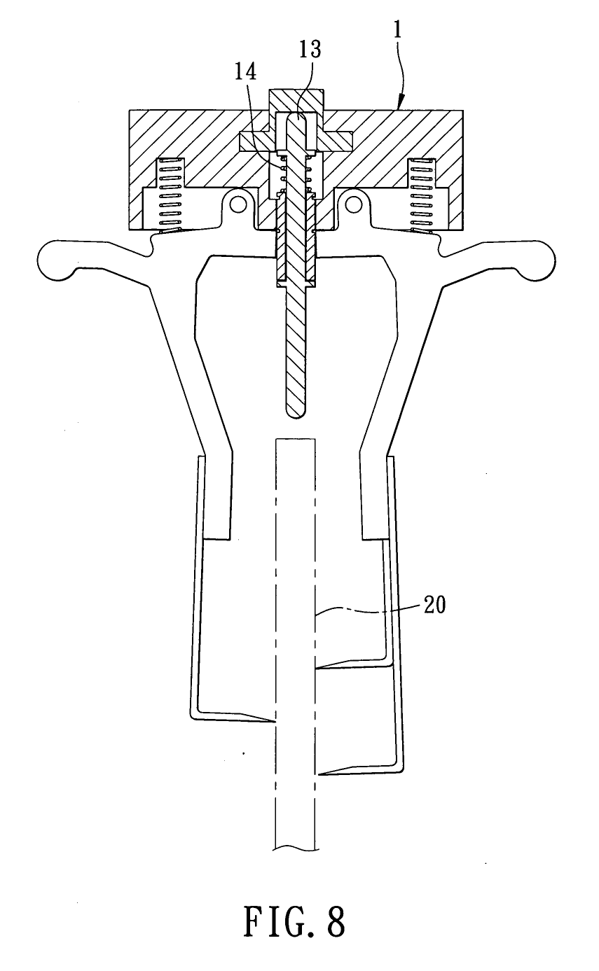

The push rod 13 is inserted movably into the slide groove 111 through the tubular sleeve 115 and the large diameter hole section 116 so as to abut against the pushing surface 121 of the push piece 12, and projects downwardly from the main body 11 so as to abut against an object 20 to be processed. The push rod 13 is movable along a transverse direction that is transverse to the transport direction (T) between a push position and a release position. In the push position, as shown in FIGS. 6 and 7, the push rod 13 abuts against the pushing surface 121 so as to push the object 20 downwardly. In the release position, as shown in FIGS. 7 and 8, the push rod 13 moves past the pushing surface 121, and is spaced apart from the object 20. The push rod 13 includes a shank portion 131, a first flanged portion 132 extending outwardly and radially from the shank portion 131 and disposed in the large diameter hole section 116, and a second flanged portion 133 spaced apart from the first flanged portion 132, disposed outwardly of the through hole 110, and abuttable against a bottom end of the tubular sleeve 115. The second flanged portion 133 abuts against the bottom end of the tubular sleeve 115 when the push rod 13 is in the release position so as to limit upward movement of the push rod 13 toward the track 31.

The resilient restoring element 14, in this embodiment, is a helical spring sleeved on the shank portion 131 of the push rod 13 within the large diameter hole section 116 and having two opposite ends abutting respectively against the first flanged portion 132 and a top end of the tubular sleeve 115. The restoring element 14 biases the push rod 13 to move upwardly toward the track 21. In an alternative embodiment, the restoring element 14 may be a rubber body.

The grip arms 15, 15′ are connected pivotally to the main body 11 in a conventional manner, are respectively disposed on two opposite sides of the push rod 13, and are abuttable respectively against the limiting portions 113. The limiting portions 113 limit pivot movement of the grip arms 15, 15′ toward the push rod 13. The grip arm 15 has a grip end 151. The grip arm 15′ has two grip ends 151′ spaced apart from each other along the transverse direction. The grip ends 151, 151′ cooperate to grip the object 20 (see FIGS. 6 and 8) therebetween. The grip ends 151, 151′ lie on a same axial line when the grip arms 15, 15′ are in a non-gripping position. It is worth mentioning that the grip ends 151, 151′ may be made of resilient plastic or rubber, so that the grip ends 151, 151′ may deform to conform with an outer shape of the object 20, thereby stably gripping the object 20.

Each of the spring members 16 has one end extending into the extension 1121 of one of the cavities 112, and the other end abutting against a respective grip arm 15, 15′. Each spring member 16 biases one of the grip arms 15, 15′ toward the other one of the grip arms 15, 15′ so that the grip ends 151, 151′ of the grip arms 15, 15′ may cooperate with each other to grip the object 20 therebetween.

A universal connecting element 17, as shown in FIG. 7, has a ball-shaped section 172 received rotatably in the engaging groove 114′, and a connecting section 171 projecting outwardly from the ball-shaped section 172 through the engaging groove 114′ so as to engage the engaging groove 114 in the main body 11 of an adjacent grip unit 1.

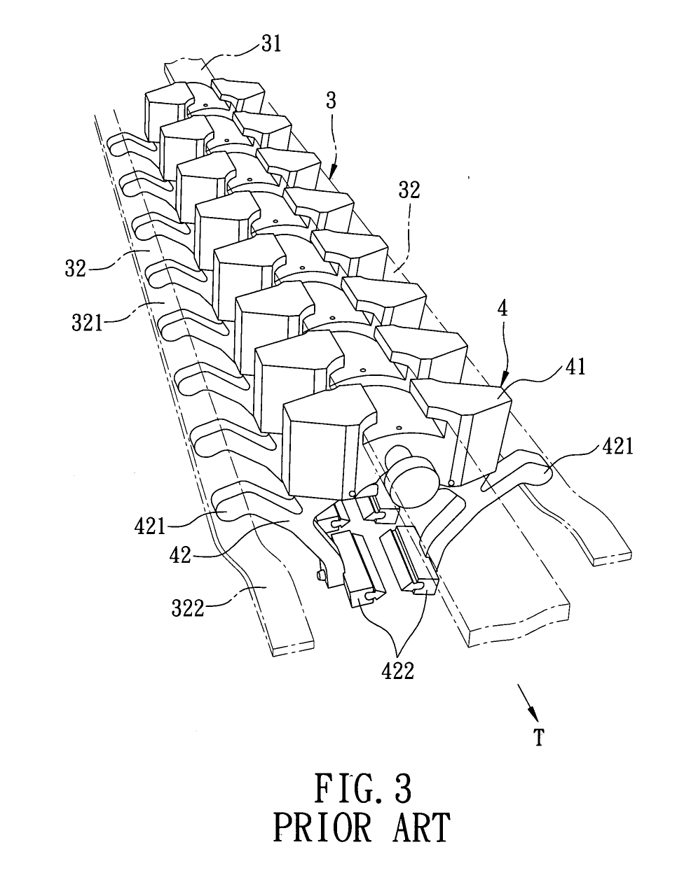

To use the conveyor 2, with reference to FIGS. 4 and 7, the grip units 1 are connected in series along the track 21 by engaging the connecting section 171 of the connecting element 17 of one of the grip units 1 to the engaging groove 114 in an adjacent one of the grip units 1. Since the principles involved in the gripping and releasing of the object 20 by the grip unit 1 are similar to those described in the grip unit 4 of the conventional conveyor 3 (see FIG. 3), a detailed description of the same is dispensed herewith for the sake of brevity.

With reference to FIGS. 6 to 8, when the grip unit 1 grips the object 20, and is activated by a drive element (not shown) to move along the track 21 in the transport direction (T) (see FIG. 4), as the push rod 13 moves to abut against the pushing surface 121, the push rod 13 pushes the object 20 downwardly and away from the main body 11. The push rod 13 is in the push position at this time. When the grip unit 1 continues to move along the track 21 until the push rod 13 moves past the push piece 12, the restoring element 14 biases the push rod 13 to move upwardly toward the track 21 and back to its original position. At this time, the push rod 13 is in the release position, and the object 20 is spaced apart from the push rod 13.

Since the grip unit 1 moves along the track 21 until the push rod 13 abuts against the pushing surface 121 of the push piece 12 so as to push the object 20 downwardly and away from the main body 11, when the object 20 is to undergo a chemical surface treatment, such as electroplating or anodizing, the length of the object 20 that extends into a chemical liquid bath can be increased. Hence, the manual operation employed in the conventional conveyor 3 (see FIG. 3) can be dispensed herewith. Further, problems associated with shifting of the object in the conventional conveyor 3 can also be avoided, so that the quality of the object 20 that undergoes the chemical surface treatment can be ensured.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

I claim:

1. A conveyor comprising:
a track extending along a transport direction; and
a grip unit including a main body disposed below said track and having a slide groove that receives slidably said track, a push piece provided on said track at a predetermined position and having a pushing surface to face said slide groove, a push rod inserted movably into said slide groove to abut against said pushing surface and projecting downwardly from said main body, a resilient restoring element for biasing said push rod upwardly, two grip arms connected pivotally to said main body and disposed respectively on two opposite sides of said push rod, and two spring members each disposed between said main body and a respective said grip arm to bias one of said grip arms toward the other one of said grip arms so that said grip arms cooperate with each other to grip an object therebetween;
said push rod being movable downwardly to push the object when said push rod abuts against said pushing surface.

2. The conveyor of claim 1, wherein said main body further has a through hole extending downwardly from and communicated spatially with said slide groove, said push rod including a shank portion extending into said slide groove through said through hole, said restoring element being a helical spring sleeved on said shank portion within said through hole.

3. The conveyor of claim 2, wherein said through hole has a small diameter hole section distal from said slide groove, and a large diameter hole section between said slide groove and said small diameter hole section, said push rod further including a first flanged portion extending outwardly and radially from said shank portion and disposed in said large diameter hole section, said restoring element having one end abutting against said first flanged portion.

4. The conveyor of claim 3, wherein said main body further has a tubular sleeve fixed in said small diameter hole section and extending out of said through hole, said shank portion of said push rod extending through said tubular sleeve, said restoring element further having another end abutting against said tubular sleeve.

5. The conveyor of claim 4, wherein said push rod further includes a second flanged portion disposed outwardly of said through hole and abuttable against said tubular sleeve to limit upward movement of said push rod toward said track.

6. The conveyor of claim 1, wherein said pushing surface of said push piece is an inclined surface that slants downwardly in said transport direction.

7. The conveyor of claim 1, wherein said main body further has two cavities disposed respectively on two opposite sides of said through hole, each of said spring members having one end extending into one of said cavities, and the other end abutting against a respective said grip arm.

8. The conveyor of claim 1, wherein said main body further includes two limiting portions disposed respectively on two opposite sides of said push rod and abutting respectively against said grip arms to limit pivot movement of said grip arms toward said push rod, each of said grip arms including at least one grip end, said grip ends of said grip arms lying on a same axial line when said grip arms are in a non-gripping position.

9. The conveyor of claim 1, wherein said main body further has two ends opposite to each other along said transport direction, an engaging groove provided in one of said ends, and a universal connecting element that has a ball-shaped section received in said engaging groove, and a connecting section projecting outwardly from said ball-shaped section through said engaging groove.
